(19) United States
(12) Patent Application Publication
(10) Pub. No.: US 2024/0296381 A1
(43) Pub. Date: Sep. 5, 2024

(54) PROGRAM INFORMATION PROVIDING APPARATUS, PROGRAM INFORMATION PROVIDING METHOD, AND RECORDING MEDIUM

(71) Applicant: NEC Corporation, Tokyo (JP)

(72) Inventors: Fumihide TAKIMOTO, Tokyo (JP); Munehiro HASHIMOTO, Tokyo (JP); Yuka ENDO, Tokyo (JP)

(73) Assignee: NEC Corporation, Tokyo (JP)

(21) Appl. No.: 18/442,561

(22) Filed: Feb. 15, 2024

(30) Foreign Application Priority Data
Mar. 2, 2023 (JP) 2023-031952

(51) Int. Cl. G06N 20/00

(52) U.S. Cl. CPC G06N 20/00

(57) ABSTRACT

The program information providing apparatus includes an acquisition unit and a prediction unit. The acquisition unit acquires information regarding race organization in a target race of public competition. The prediction unit predicts the difficulty level of a result prediction of the target race using a model in which a relationship between information regarding the race organization and a difficulty level of a race result prediction is machine-learned and the information regarding the race organization of the target race.

This application is based upon and claims the benefit of priority from Japanese Patent Application No. 2023-31952, filed on Mar. 2, 2023, the disclosure of which is incorporated herein in its entirety by reference.

### TECHNICAL FIELD

The present disclosure relates to a program information providing apparatus or the like that provides information regarding a program in a public competition.

### BACKGROUND ART

In a public competition, an organizer of a race determines a competitor or a racehorse to participate in the race, for example, based on a difficulty level of race arrival order prediction. For example, PTL 1 (JP 2006-085441 A) describes extracting a payout for a successful race from past competition information and calculating a difficulty level evaluation point according to the difficulty level of the race from the payout.

### SUMMARY

An object of the present disclosure is to provide a device and the like capable of predicting a difficulty level of a race result prediction.

A program information providing apparatus according to one aspect of the present disclosure includes at least one memory storing instructions; at least one processor configured to execute the instructions to acquire information regarding race organization in a target race of a public competition, and predict a difficulty level of a result prediction of the target race using a model in which a relationship between information regarding the race organization and a difficulty level of a race result prediction is machine-learned and the information regarding the race organization of the target race.

In a program information providing method according to an aspect of the present disclosure includes acquiring information regarding race organization in a target race of a public competition, and predicting a difficulty level of a result prediction of the target race using a model in which a relationship between information regarding the race organization and a difficulty level of a race result prediction is machine-learned and the information regarding the race organization of the target race.

A non-transitory recording medium according to one aspect of the present disclosure that records a program for causing a computer to execute acquiring information regarding race organization in a target race of a public competition, and predicting a difficulty level of a result prediction of the target race using a model in which a relationship between the information regarding the race organization and a difficulty level of a race result prediction is machine-learned and the information regarding the race organization of the target race.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating an example of a configuration of an information processing system according to an example embodiment of the present disclosure;

FIG. 2 is a block diagram illustrating an example of a configuration of a program information providing apparatus according to the example embodiment of the present disclosure;

FIG. 3 is a diagram illustrating an example of a display screen of a terminal device according to the example embodiment of the present disclosure;

FIG. 4 is a flowchart illustrating an example of an operation performed by the program information providing apparatus according to the example embodiment of the present disclosure;

FIG. 5 is a flowchart illustrating an example of the operation performed by the program information providing apparatus according to the example embodiment of the present disclosure;

FIG. 6 is a flowchart illustrating an example of a prediction model generation operation performed by the program information providing apparatus according to the example embodiment of the present disclosure;

FIG. 7 is a block diagram illustrating an example of a configuration of the program information providing apparatus according to the example embodiment of the present disclosure;

FIG. 8 is a flowchart illustrating an example of the operation performed by the program information providing apparatus according to the example embodiment of the present disclosure; and

FIG. 9 is a block diagram illustrating an example of a hardware configuration.

### EXAMPLE EMBODIMENT

### First Example Embodiment

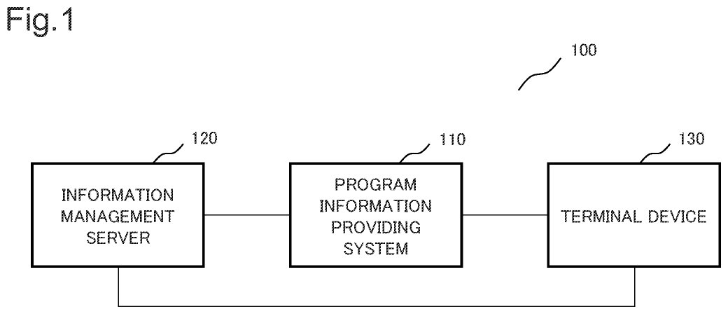

FIG. 1 is a block diagram illustrating an example of a configuration of an information processing system 100 according to a first example embodiment. As an example, the information processing system 100 of the present exemplary embodiment includes a program information providing apparatus 10, an information management server 120, and a terminal device 130. The program information providing apparatus 110, the information management server 120, and the terminal device 130 are connected so as to be able to communicate with each other via a wireless or wired communication network such as Wi-fi or Bluetooth (registered trademark). A plurality of information management servers 120 and a plurality of terminal devices 130 may be provided.

The program information providing apparatus 110 is an apparatus that provides information regarding a program of a race in a public competition. The public competition is, for example, a horse race. The public competition may be a bicycle race, a boat race, or an auto race. The example of the public competition is not limited to the above, and the type of competition is not limited as long as it is a competition held as a gamble by a public institution.

A program of the race is, for example, a combination of competitors participating in the race. The competitor is an entity that participates in the race. In a case where the public competition is a horse race, the competitor is a horse. In a case where the public competition is a bicycle race, a boat race, or an auto race, the competitor is a player. The program may include a condition of each competitor participating in the race. The condition of each competitor participating in the race is, for example, information regarding a lane assigned to the competitor participating in the race. The condition of each competitor participating in the race may be a handicap imposed on each competitor.

The program information providing apparatus 110 predicts a difficulty level of a result prediction of a race of a public competition by using the prediction model. The prediction model is a model that outputs a difficulty level of the result prediction of the race using information regarding the race organization of the public competition as an input. The prediction model may be a model generated outside the program information providing apparatus 110. The prediction model will be described later.

The information regarding the race organization is information necessary for the composition of the race program. The information regarding the race organization includes at least information indicating the competitor participating in the race. The information regarding the race organization may include a race condition. The information regarding the race organization may include, for example, information that may affect the difficulty level of the race result prediction. In this case, the information regarding the race organization may include, for example, an attribute of the competitor participating in the race and a start position of the competitor.

The race condition is, for example, information regarding a stadium, a setting condition of the race, and a condition to be satisfied by the participating competitor. The attribute of the competitor is information regarding each competitor participating in the race. In a case where the public competition is a horse race, the attribute of the competitor may also include information regarding a rider. In a case where the public competition is a bicycle race, a boat race, or an auto race, the attribute of the competitor may include information regarding a bicycle, a boat, or a motorcycle. The information regarding the race organization is not limited to the above example.

The race conditions and attributes of the competitor participating in the race may affect the difficulty level of the race result prediction. For example, in the case of a race with a long distance, a program in which many competitors having a winning record in a race with a long distance are included has a high difficulty level in predicting the race result. When the difficulty level of the race result prediction increases, the variation in the race result prediction for each person who purchases a voting ticket of the race increases, so that the odds of the voting ticket in the actual race can increase.

The difficulty level of the race result prediction may affect the presence or absence of purchase of voting tickets for the race. The difficulty level of the race result prediction can affect the sales amount of voting tickets for the race. In a case where the difficulty level of the race result prediction is high, for example, the possibility that the race result prediction and the actual race result match is reduced, and the amount of reclaiming money is increased. Therefore, attraction as a race for the voting ticket purchase target can be improved. Meanwhile, in a case where the difficulty level in predicting the race result is high, it is difficult for a beginner to predict the race, and there may be a case where the beginner is excluded from the voting ticket purchase target. Therefore, the organizer of the race sets the difficulty level of the race result prediction according to, for example, a purchaser group assumed as the purchaser of the voting ticket of the race.

The information management server 120 is, for example, a server that stores information regarding the race organization of the public competition. The information management server 120 may store data in which information regarding the race organization in the past race is associated with the difficulty level of the result prediction of the race. The information management server 120 may store the prediction model.

The terminal device 130 is, for example, a terminal device used by a person who uses an output result by the program information providing apparatus 110 to confirm the output result. The output result is, for example, a difficulty level predicted by the prediction model based on the information regarding the race organization. The person who uses the output result by the program information providing apparatus 110 is, for example, a person in charge of program organization in the organizer of the race, but is not limited to the above example. A person who uses the output result by the program information providing apparatus 110 is hereinafter referred to as a user.

The terminal device 130 acquires the difficulty level of the race result prediction from the program information providing apparatus 110. Then, program information providing apparatus 110 outputs the difficulty level of the race result prediction to the terminal device 130.

In a case where the prediction model to be described later is designated by the user, the terminal device 130 acquires, for example, the name of the prediction model input by the operation of the user. Then, the terminal device 130 outputs the name of the input prediction model to the program information providing apparatus 110.

As the terminal device 130, for example, a smartphone, a tablet computer, a notebook computer, or a desktop computer is used. The terminal device 130 includes, for example, at least one of a display unit capable of displaying characters and images such as a display, a sound output unit capable of outputting sound such as a speaker, and the like. The terminal device 130 presents the difficulty level of the race result prediction to the user using at least one of the display unit, the sound output unit, and the like. The device used as the terminal device 130 is not limited to the above example.

For example, the program information providing apparatus 110 acquires, from the terminal device 130, information regarding the race organization in a target race. Then, the program information providing apparatus 110 uses the information regarding the race organization acquired from the terminal device 130 as an input, and predicts the difficulty level of the result prediction of the target race using the prediction model. After predicting the difficulty level of the result prediction of the target race, the program information providing apparatus 110 outputs the difficulty level to the terminal device 130.

The program information providing apparatus 110 may acquire the information regarding the race organization from the information management server 120. The program information providing apparatus 110 may acquire information regarding the race organization from a plurality of information management servers 120.

The program information providing apparatus 110 may output the difficulty level of the result prediction of the target race to the plurality of terminal devices 130. For example, the program information providing apparatus 110 may output the difficulty level to the terminal device 130 used by a plurality of users. The program information providing apparatus 110 may output the difficulty level to the information management server 120.

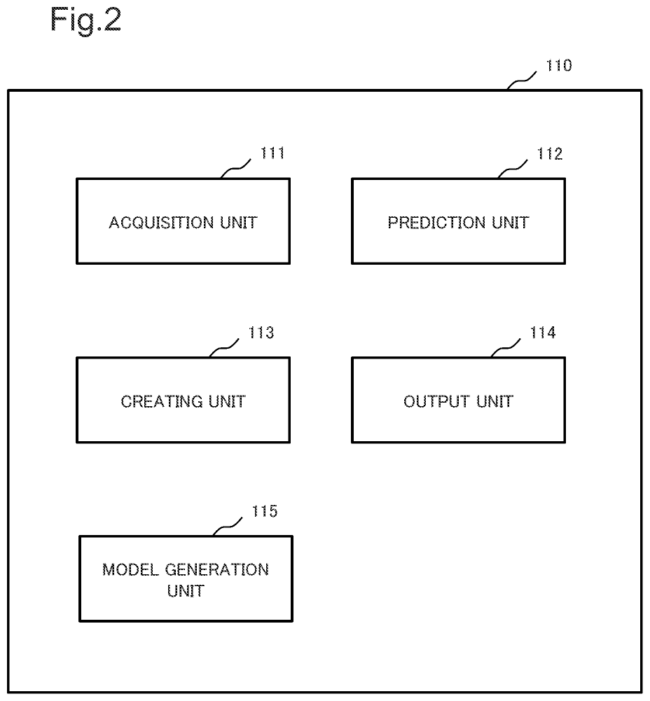

A configuration of the program information providing apparatus 110 will be described. FIG. 2 is a block diagram illustrating an example of a configuration of program information providing apparatus 110 according to the present exemplary embodiment. The program information providing apparatus 110 includes an acquisition unit 111, a prediction unit 112, a creating unit 113, an output unit 114, and a model generation unit 115. The acquisition unit 111, the prediction unit 112, the creating unit 113, and the output unit 114 perform processing regarding the prediction of the difficulty level of the race result prediction, for example. The acquisition unit 111 and the model generation unit 115 perform processing regarding the generation of the prediction model, for example.

The acquisition unit 111 serves as an acquisition means for acquiring the information regarding the race organization in the target race of the public competition. The target race is a race for which the difficulty level of the race result prediction is to be predicted. That is, the acquisition unit 111 acquires information of a program of a race organized by the user. The acquisition unit 111 acquires, for example, the competitor who will participate in the race, the race condition, and the attribute of each competitor as the information regarding the race organization.

In a case where the public competition is a horse race, the race conditions are, for example, information regarding the racecourse, race setting conditions, and conditions to be satisfied by the racehorse that will participate in the race. The race condition may include a race date. The race conditions include, for example, at least one or more of a distance, a type of a riding course, a condition of a racehorse, a weight, a rating of a race, a racecourse, the number of racehorses to participate, and a traveling direction. The type of riding course is, for example, a distinction between turf, dart, or obstacle. The condition of the racehorse is, for example, an exit condition defined by the age and sex of the horse. The traveling direction is, for example, information indicating whether the race is performed counterclockwise or clockwise. The race condition in the case where the public competition is a horse race is not limited to the above example.

When the public competition is a horse race, the attribute of the competitor is the attribute of the racehorse. The attribute of the racehorse is information regarding each racehorse. The attribute of the racehorse is, for example, at least one or more of an age, a sex, weight, a weight change, blood data, a muscle mass, a training situation, a health condition, a rest history, a race exit history, a weight bearing, a leg quality, a record, a breed, a stable owner, groom, and a producer. The blood line is, for example, information regarding a father's horse and a mother's horse. The attribute of the racehorse may include information regarding the rider. The training situation is, for example, time and time change for each distance at the time of training. The leg quality is set by, for example, a classification of a runaway horse, a preceding horse, a wagon, or a running-in horse. The attribute of the racehorse may include the records of the father and the mother. The records are, for example, a race condition in a past race, an attribute of a racehorse at the time of the race, an acquired prize money, and a race development. The race development is, for example, positioning and difference in time. The positioning is, for example, the order and time in each section when the entire section of the race is divided for each predetermined distance. The difference in time is, for example, a time difference from a racehorse of a higher rank or a racehorse of a lower rank. The attribute of the racehorse is not limited to the above example.

In a case where the public competition is a bicycle race, the condition of the race is, for example, at least one or more of a racecourse and a competitive distance. The attribute of the competitor is at least one or more of the height, weight, age, leg quality, and record of the player. In a case where the public competition is a bicycle race, examples of the race condition and the attribute of the competitor are not limited to the above.

In a case where the public competition is a boat race, the race condition is, for example, at least one or more of a racecourse and a competitive distance. The attribute of the competitor is at least one or more of the height, weight, age, rank, and record of the player. In a case where the public competition is a boat race, examples of the race conditions and the attributes of the competitor are not limited to the above.

When the public competition is an auto race, the condition of the race is, for example, at least one or more of the racecourse and the presence or absence of the handicap. The attribute of the competitor is at least one or more of the height, weight, age, affiliation, rank, and record of the player. Examples of the race condition and the attribute of the competitor in a case where the public competition is an auto race are not limited to the above.

The acquisition unit 111 may acquire a target difficulty level of the race result prediction. For example, the acquisition unit 111 acquires the target difficulty level of the race result prediction from the terminal device 130. The target difficulty level of the race result prediction is input to the terminal device 130 by, for example, a person in charge of organizing the program.

In a case where a plurality of prediction models are used, the acquisition unit 111 may acquire designation of a prediction model used by the prediction unit 112 from the terminal device 130. The acquisition unit 111 acquires, from the terminal device 130, designation of a prediction model input to the terminal device 130 by a user operation, for example.

In a case where the program information providing apparatus 110 generates the prediction model, the acquisition unit 111 may acquire, as training data for generating a prediction model, information regarding the race organization and the difficulty level of the race result prediction in the race performed in the past. The acquisition unit 111 acquires, for example, training data in which the difficulty level of the result prediction of the race is associated with the competitor participating in the race, the race condition, the attribute of the competitor participating in the race, and the start position of the competitor.

The prediction unit 112 serves as a prediction unit that predicts the difficulty level of the result prediction of the target race using the prediction model and the information regarding the race organization of the target race acquired by the acquisition unit 111. The prediction model is a model that predicts the difficulty level of the result prediction of the target race based on information regarding the race organization of the target race. The prediction model outputs the difficulty level of the result prediction of the target race with information regarding the race organization of the target race as an input. The prediction model is a model in which the relationship between the information regarding the race organization and the difficulty level of the race result prediction is learned.

The difficulty level of the race result prediction is expressed by, for example, a score. The score is, for example, a value of 0 or more and 1 or less. In this case, the score closer to 1 indicates that the difficulty level is higher, and the score closer to 0 indicates that the difficulty level is lower. For example, with a predetermined value of 0 or more and 1 or less as a threshold, it is determined whether it is difficult or easy to predict the race result based on the threshold. The score may be a value expressed by a binary value of 0 or 1. In this case, the score indicates 1 when the race result prediction is difficult, and indicates 0 when the race result prediction is easy.

The difficulty level of the race result prediction may be expressed by, for example, a predetermined number of alphabets. The difficulty level of the race result prediction may be expressed by a target layer of the program. In this case, the difficulty level of the race result prediction may be expressed as, for example, for an expert when the difficulty level of the race result prediction is high, and for a beginner when the difficulty level of the race result prediction is low.

As the information indicating the difficulty level of the race result prediction, information regarding odds may be used. In general, the higher the odds, the higher the difficulty level of race result prediction. In this case, for example, the prediction model uses information regarding the race organization of the target race as an input, and outputs the odds of a predetermined competitor as information regarding the odds. The prediction model may output the highest value and/or the lowest value of the odds in the target race. At that time, the prediction model may also output the competitor related to the highest value and/or the lowest value of the odds.

In a case where a prediction model capable of estimating the reason why the difficulty level of race result prediction is output is used, the prediction unit 112 may estimate the reason why the difficulty level of the race result prediction is output using the prediction model.

The creating unit 113 is responsible for a creating unit that creates a program change proposal in which at least a part of the information regarding the race organization in the target race is changed. The creating unit 113 creates a program change proposal in which at least a part of changeable information in the information regarding the race organization is changed. The changeable information among the information regarding the race organization is information determined by the user at the time of program organization. The changeable information among the information regarding the race organization is, for example, information indicating the competitor who will participate in the race. The changeable information among the information regarding the race organization is, for example, the start position of the competitor. Here, since the start position of the competitor is determined by lottery depending on the type of public competition, it is not information determined by the user. Therefore, in the public competition in which the start position of the competitor is determined by lottery, the start position of the competitor is not included in the changeable information of the information regarding the race organization. The changeable information among the information regarding the race organization may be set in advance by the user.

In a case where the changeable information among the information regarding the race organization is, for example, the competitor who participates in the race, the creating unit 113 creates the program organization in which some of the competitors who participate in the race are changed as a program change proposal. At this time, the creating unit 113 may determine a competitor not assigned to the target race as an alternative competitor from among competitors having the same race condition as the competitor to be changed, and create the alternative competitor as the program change proposal.

The output unit 114 outputs the difficulty level of the result prediction of the target race predicted by the prediction unit 112. The output unit 114 outputs the difficulty level of the result prediction of the target race to the terminal device 130, for example. The output unit 114 outputs the difficulty level of the result prediction of the target race, which is the prediction result, in a format that can be output by an output device (not illustrated) connected to terminal device 130 or program information providing apparatus 110. For example, in a case where the terminal device 130 or the output device includes a display unit such as a display that outputs the prediction result, the output unit 114 has a function as a display control unit that controls the display unit. In this manner, the output unit 114 can function as a unit that controls the terminal device 130 or the output device according to the format of the determination result output in the terminal device 130 or the output device.

In a case where the difficulty level of the race result prediction is the information regarding the odds, and the prediction unit 112 extracts the competitor related to the odds together, the output unit 114 may output the information regarding the odds, which is the difficulty level of the race result prediction, and the competitor related to the odds. When the prediction unit 112 estimates the reason why the difficulty level of race result prediction is output, the output unit 114 may output the difficulty level of race result prediction and the reason.

The output unit 114 may output the information regarding the race organization in the past race in addition to the difficulty level of the result prediction of the target race. The output unit 114 may output the information regarding the race organization in the past race selected based on the difficulty level of the target race. In this case, for example, the output unit 114 may output information regarding the race organization in the past race in which the difficulty level of the race result prediction matches the difficulty level of the target race predicted by the prediction unit 112. For example, in a case where the acquisition unit 111 acquires the target difficulty level of the race result prediction, the output unit 114 may output information regarding the race organization in the past race selected based on the target difficulty level. In this case, for example, the output unit 114 may output information regarding the race organization in the past race in which the difficulty level of the race result prediction matches the target difficulty level. The information regarding the race organization in the past race output by the output unit 114 may include not only those having the same difficulty level but also those having similar difficulty levels.

When the creating unit 113 creates the program change proposal, the output unit 114 may output the program change proposal. When the creating unit 113 creates a plurality of program change proposals, the output unit 114 may output all of the plurality of program change proposals, or may output a predetermined number of program change proposals. In a case where the acquisition unit 111 acquires the target difficulty level of the race result prediction, the output unit 114 may output a program change proposal in which the difficulty level of the race result prediction predicted by the prediction unit 112 matches the target difficulty level among the program change proposals created by the creating unit 113.

The output unit 114 may output a display screen for performing an operation of changing information regarding the race organization. In a case where the creating unit 113 creates the program change proposal, the output unit 114 may output, for example, a display screen on which the user selects the program change proposal.

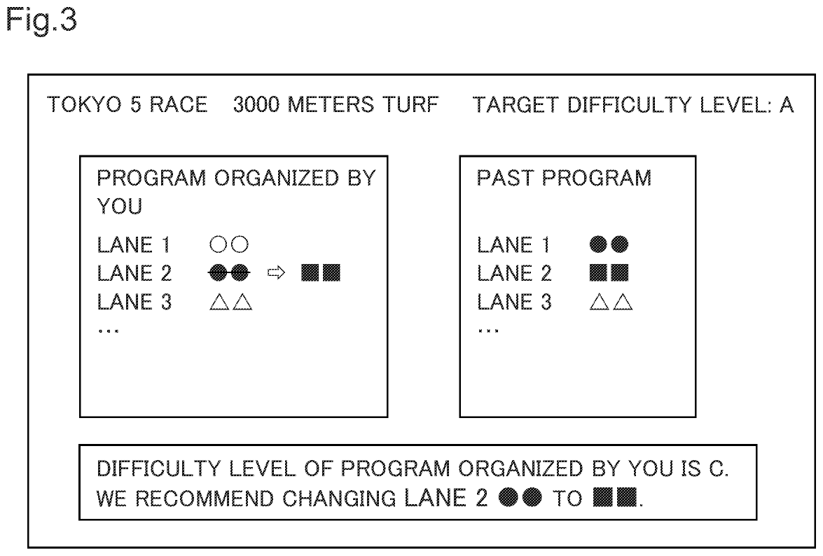

FIG. 3 is an example of a display screen in a case where the difficulty level of the result prediction of the target race and the like are displayed on the terminal device 130. In the example of the display screen of FIG. 3, “Tokyo” indicating the name of a racecourse, a “race 5” indicating the race number, “3000 meters” indicating the race distance, and “turf” indicating the race type are displayed on the upper part of the display screen. In the example of the display screen of FIG. 3, the difficulty level of the race result prediction is displayed. FIG. 3 illustrates a case where the difficulty level is set in three stages of alphabets A to C.

The display screen of FIG. 3 is displayed, for example, in a case where the race to be predicted of the difficulty level of the race result prediction is organized by the user. The program organized by the user is displayed on the left part of the display screen as “program organized by you”. In the example of the display screen of FIG. 3, a past program is displayed on the right part of the display screen as information regarding race organization in the past race. The displayed past program may be selected based on the difficulty level of the program organized by the user, or may be selected based on the target difficulty level. Furthermore, in the example of the display screen of FIG. 3, the difficulty level of the program organized by the user and the program change proposal are displayed at the lower part of the display screen. Here, only the program change portion and the change content are displayed as the program change proposal. In displaying the program change proposal, as illustrated in the example of the display screen of FIG. 3, the program organized by the user may be superimposed and displayed so as to directly indicate the change portion and the change content.

In a case where the prediction model is generated in the program information providing apparatus 110, the model generation unit 115 generates a prediction model that predicts the difficulty level of the result prediction of the target race based on the information regarding the race organization of the target race. The model generation unit 115 learns, for example, the relationship between the information regarding the race organization in the past race and the difficulty level of the result prediction of the race, and generates the prediction model.

The model generation unit 115 generates the prediction model by deep learning using a neural network, for example. In the case of generating the prediction model by the deep learning using the neural network, the model generation unit 115 learns a relationship between information regarding the race organization and the difficulty level by using training data indicating a relationship between information regarding the race organization in the race of the public competition and the difficulty level of the result prediction of the race, and generates the prediction model of the difficulty level. In this prediction model, the information regarding the race organization is the explanatory variable, and the difficulty level is the objective variable. The explanatory variable may be one kind or plural kinds.

For example, the model generation unit 115 may change the data (explanatory variable) of each item included in the input data, and estimate the data (explanatory variable) of the item having a large influence on the prediction result as the reason for the predicted difficulty level based on the change in the difficulty level (objective variable) of the race result prediction which is the prediction result. For example, the model generation unit 115 changes the data of each item included in the input data of the prediction model, and estimates the item having a large influence on the prediction result as the reason for the predicted difficulty level.

The model generation unit 115 may generate the prediction model using, for example, a learning algorithm based on a factorized asymptotic Bayesian inference. When performing learning using the learning algorithm based on the factorized asymptotic Bayesian inference, the model generation unit 115 uses training data in which the information regarding the race organization is the input data and the difficulty level of the race result prediction related to the information is used as correct answer data. This learning algorithm includes three steps. The first step is a step of classifying data according to a rule in a decision tree format, the second step is a step of generating a plurality of prediction models using a linear model in which different explanatory variables are combined in each case, and the third step is a step of deleting an unnecessary prediction model from among the generated prediction models. The model generation unit 115 generates the prediction model by sequentially and repeatedly performing the processing of these steps, that is, optimization of a data case division condition, generation of the prediction model by optimization of a combination of explanatory variables (data of each item included in the input data), and deletion of an unnecessary prediction model. In the case of using the prediction model generated by the method of generating the learning model by a combination of different explanatory variables, it is possible to describe the prediction result by using a case-by-case condition in which the difficulty level of the race result prediction has a strong influence on the prediction result, so that the interpretability of the prediction result of the difficulty level is improved. A method for generating such a learning model is disclosed in, for example, JP 2016-509271 W (US 2014/0222741 A). The learning algorithm used for the machine learning for generating the prediction model is not limited to the above example.

The generated prediction model may be stored in the information management server 120 or may be stored in a storage unit (not illustrated) in the program information providing apparatus 110.

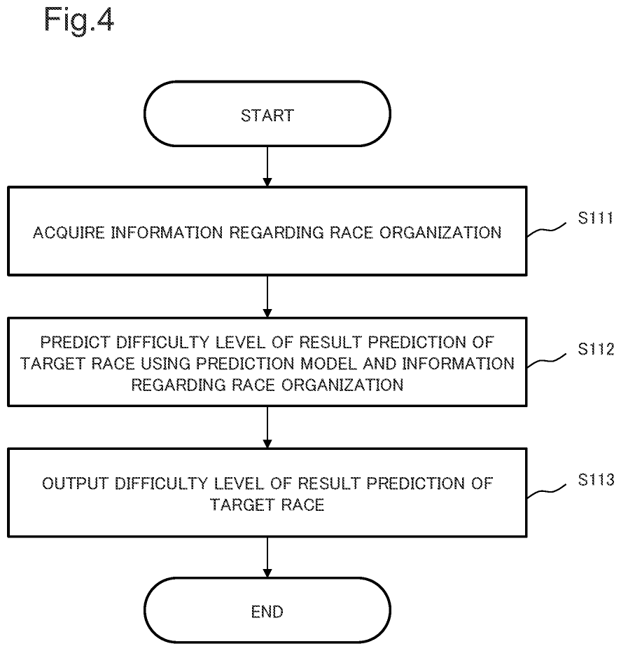

Next, the operation of the program information providing apparatus 110 will be described. FIG. 4 is a flowchart illustrating an example of the operation (program information providing method) performed by the program information providing apparatus 110 according to the present example embodiment.

The acquisition unit 111 acquires the information regarding the race organization in the target race of the public competition (Step S111). The acquisition unit 111 acquires, for example, information regarding the race organization from information management server 120. The prediction unit 112 predicts the difficulty level of the result prediction of the target race using the prediction model and the information regarding the race organization of the target race acquired by the acquisition unit 111 (Step S112). The output unit 114 outputs the difficulty level of the result prediction of the target race predicted by the prediction unit 112 to a predetermined output device (Step S113). The output unit 114 outputs the difficulty level of the result prediction of the target race to the terminal device 130, for example.

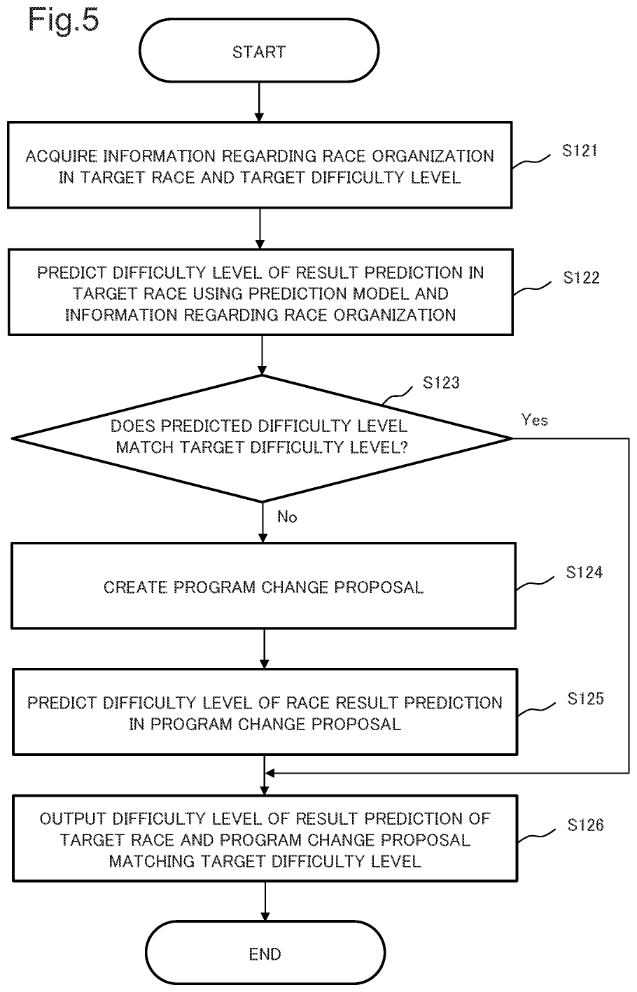

An example of the operation of the program information providing apparatus 110 in a case where the target difficulty level is acquired and the program change proposal is created will be described. FIG. 5 is a flowchart illustrating an example of the operation of the program information providing apparatus 110 in the above-described case.

For example, the acquisition unit 111 acquires, from the information management server 120, information regarding the race organization in the target race and the target difficulty level in the target race (Step S121). The acquisition unit 111 acquires, for example, information regarding the race organization from information management server 120.

The prediction unit 112 predicts the difficulty level of the result prediction in the target race using the prediction model and the information regarding the race organization of the target race acquired by the acquisition unit 111 (Step S122). Next, the prediction unit 112 compares the predicted difficulty level with the target difficulty level, and in a case where the predicted difficulty level does not match the target difficulty level (Step S123: No), the prediction unit 112 instructs the creating unit 113 to create the program change proposal.

The creating unit 113 creates the program change proposal in which at least a part of the information regarding the race organization in the target race is changed (Step S124).

The prediction unit 112 predicts the difficulty level of the race result prediction in the program change proposal created by the creating unit 113 (Step S125). In a case where a plurality of program change proposals has been created, the prediction unit 112 predicts the difficulty level of the race result prediction for each program change proposal.

The output unit 114 outputs the difficulty level of the result prediction of the target race predicted by the prediction unit 112 and the program change proposal in which the difficulty level predicted in Step S125 matches the target difficulty level among the program change proposals created by the creating unit 113 to a predetermined output device (Step S126).

Meanwhile, in a case where the difficulty level of the result prediction of the target race predicted by the prediction unit 112 matches the target difficulty level (Step S123: Yes), the output unit 114 outputs the difficulty level of the result prediction of the target race predicted in Step S122 in Step S126. In Step S126, for example, the output unit 114 outputs the program change proposal in which the difficulty level of the result prediction of the target race and the predicted difficulty level match the target difficulty level to the terminal device 130.

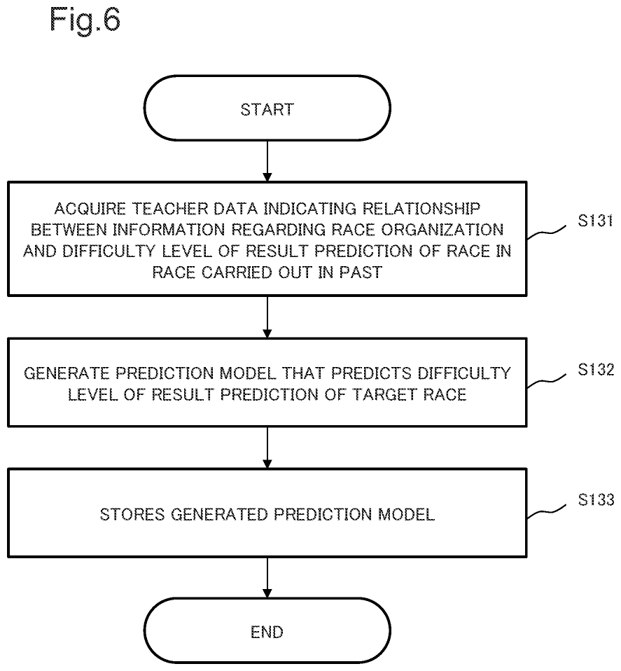

An operation (a model generation method) for generating the prediction model in the program information providing apparatus 110 will be described. FIG. 6 is a diagram illustrating an example of an operation flow when the program information providing apparatus 110 generates the prediction model.

The acquisition unit 111 acquires the training data indicating the relationship between the information regarding the race organization and the difficulty level of the result prediction of the race in the race carried out in the past (Step S131). Using the training data acquired in Step S131, the model generation unit 115 generates the prediction model that predicts the difficulty level of the result prediction of the target race based on the information regarding the race organization of the target race (Step S132). The model generation unit 115 generates the prediction model by learning the relationship between the information regarding the race organization and the difficulty level of the race result prediction. After generating the prediction model, the model generation unit 115 stores the generated prediction model in a storage unit (not illustrated) in the program information providing apparatus 110 (Step S133). The model generation unit 115 may transmit the generated prediction model to the information management server 120 in order to store the generated prediction model in the information management server 120.

The program information providing apparatus 110 of the present example embodiment acquires information regarding the program of a race organized by the user as the information regarding the race organization in the public competition. Then, the program information providing apparatus 110 predicts the difficulty level of the race result prediction based on the information regarding the program of the race organized by the user using the prediction model. In this manner, the program information providing apparatus 110 can predict the difficulty level of predicting the result of the target race.

The user refers to the difficulty level of the race result prediction output to the terminal device 130 by the program information providing apparatus 110. For example, the user can determine the necessity of the program change by comparing the difficulty level scheduled in the program organized by the user with the output difficulty level. In this manner, the program information providing apparatus 110 predicts and outputs the difficulty level of the race result prediction with respect to the information of the program of the race organized by the user, thereby performing appropriate feedback on the program organization of the user.

The program information providing apparatus 110 of the present exemplary embodiment outputs the information regarding the race organization in the past race in which the difficulty level of the race result prediction matches the difficulty level of the predicted target race. For example, the user can refer to the information regarding the race organization in the past race output to the terminal device 130 when changing the program organization. In this manner, the program information providing apparatus 110 can provide the user with information useful for the user to perform the program organization by outputting information regarding the past race organization.

The program information providing apparatus 110 according to the present exemplary embodiment creates and outputs the program change proposal in which at least a part of the information regarding the race organization in the target race is changed. For example, the user can adopt the output the program change proposal for the actual program organization. The program information providing apparatus 110 can save the user from having to organize the program. Moreover, the program information providing apparatus 110 outputs the program change proposal whose difficulty level matches the target difficulty level. By referring to the output program change proposal, the user can recognize what kind of change should be added to bring the program created by the user close to the target difficulty level. In this manner, the program information providing apparatus 110 can provide the user with information useful for the user to perform the program organization.

### Second Example Embodiment

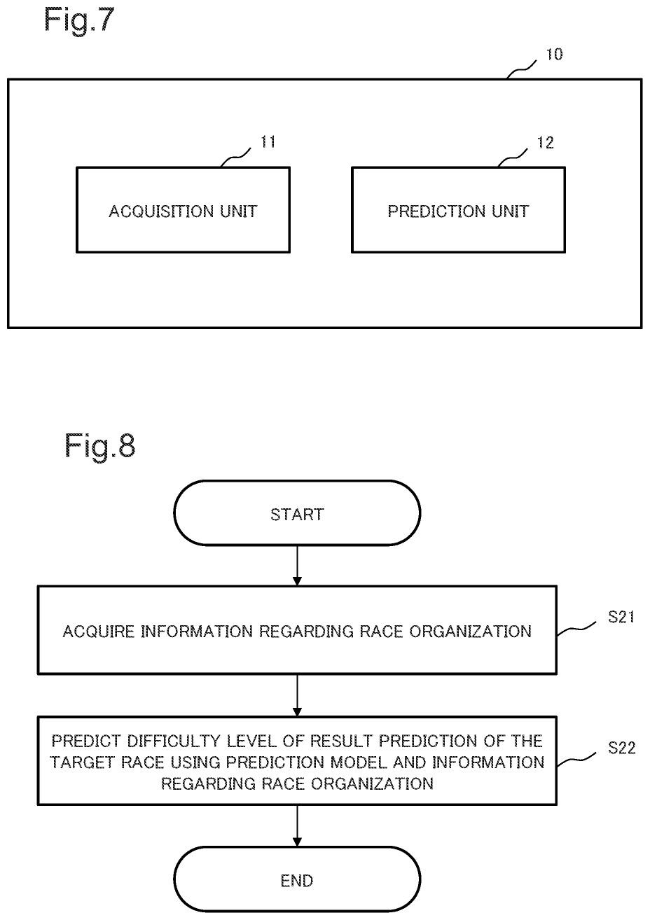

A configuration of a program information providing apparatus 10 according to a second exemplary embodiment will be described below. FIG. 7 is a block diagram illustrating a configuration of the program information providing apparatus 10 according to the second exemplary embodiment. The program information providing apparatus 10 illustrated in FIG. 7 includes an acquisition unit 11 and a prediction unit 12.

The acquisition unit 11 acquires information regarding race organization in a target race of a public competition.

The prediction unit 12 predicts a difficulty level of result prediction of the target race using a prediction model and the information regarding the race organization of the target race acquired by the acquisition unit 11. The prediction model is a model that predicts the difficulty level of the result prediction of the target race based on information regarding the race organization of the target race. The prediction model outputs the difficulty level of the result prediction of the target race with information regarding the race organization of the target race as an input. The prediction model is a model in which the relationship between the information regarding the race organization and the difficulty level of the race result prediction is learned.

Next, an operation of the program information providing apparatus 10 will be described. FIG. 8 is a flowchart illustrating an example of an operation performed by the program information providing apparatus 10 in the present example embodiment.

The acquisition unit 11 acquires information regarding the race organization in the target race of the public competition (Step S21). The prediction unit 12 predicts the difficulty level of the result prediction of the target race using the prediction model and the information regarding the race organization of the target race acquired by the acquisition unit 11 (Step S22).

According to the present example embodiment, the program information providing apparatus 10 can predict the difficulty level of predicting the result of the target race. The execution entity of each processing in the flowchart illustrated in FIG. 8 may be one processor (for example, a processor included in the program information providing apparatus 10), or a plurality of processors may perform each processing in a shared manner. The same applies to the flowchart of FIGS. 4 to 6, and one processor may execute each processing or a plurality of processors may share each processing.

### Configuration of Hardware for Achieving Each Component of Example Embodiment

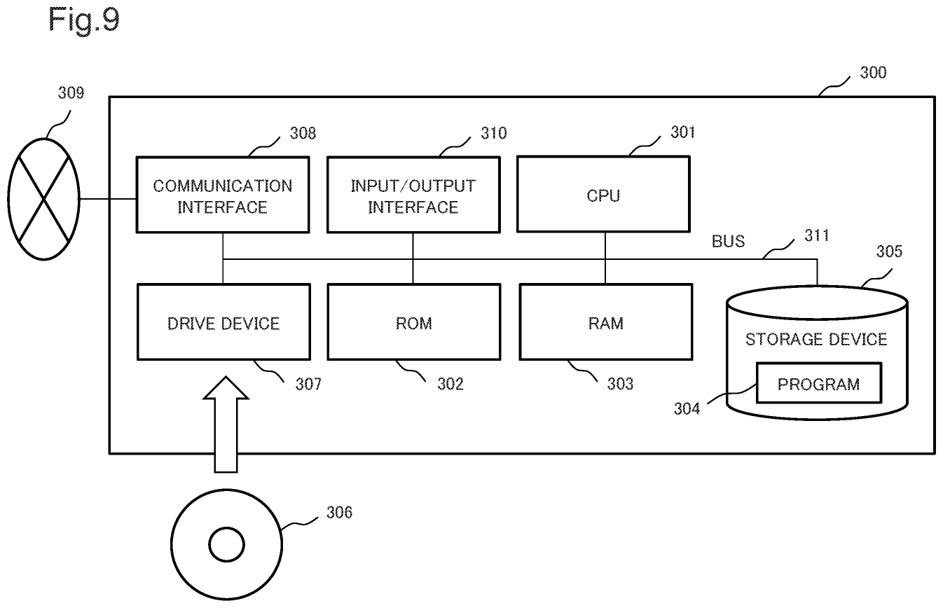

In each example embodiment of the present disclosure, each component of each device and system represents a block of a functional unit. Some or all of components of each device and system are achieved by, for example, any combination of an information processing apparatus 300 and a program as illustrated in FIG. 9. The information processing apparatus 300 includes the following configuration as an example.
Central Processing Unit (CPU) 301
Read Only Memory (ROM) 302
Random Access Memory (RAM) 303
Program 304 loaded into RAM 103
Storage device 305 storing program 304
Drive device 307 that reads and writes recording medium 306
Communication interface 308 connected with communication network 309
Input/output interface 310 for inputting/outputting data
Bus 311 connecting each component

Each component of each device in each example embodiment is achieved by the CPU 301 acquiring and executing the program 304 for achieving these functions. The program 304 for achieving the function of each component of each device is stored in the storage device 305 or the RAM 303 in advance, for example, and is read by the CPU 301 as necessary. The program 304 may be supplied to the CPU 301 via the communication network 309, or may be stored in advance in the recording medium 306, and the drive device 307 may read the program and supply the program to the CPU 301.

There are various modifications of the implementation method of each device. For example, each device may be achieved by any combination of the information processing apparatus 300 and the program separate for each component. A plurality of components included in each device may be achieved by any combination of one information processing apparatus 300 and a program.

Some or all of the components of each device are achieved by a general-purpose or dedicated circuit including a processor or the like, or a combination thereof. These may be configured by a single chip or may be configured by a plurality of chips connected via a bus. A part or all of each component of each device may be achieved by a combination of the above-described circuit or the like and a program.

In a case where some or all of the components of each device are achieved by a plurality of information processing apparatuses, circuits, and the like, the plurality of information processing apparatuses, circuits, and the like may be arranged in a centralized manner or in a distributed manner. For example, the information processing apparatus, the circuit, and the like may be achieved as a form in which each is connected via a communication network, such as a client and server system or a cloud computing system.

The configurations of the above-described example embodiments may be combined or some components may be interchanged.

In the public competition, for example, the organizer determines a competitor or a racehorse to participate in the race for each race. A combination of competitors or racehorses participating in the race is also referred to as the program. The race programs can have a significant impact on the development and order of arrival of the race. The arrival order prediction of the race is one of the pleasures for the purchaser of the voting ticket of the race. Therefore, the difficulty level of predicting the arrival order of the race may affect the presence or absence of purchase and the purchase amount of the voting ticket of the race. For this reason, the organizer of the race needs to organize a program that is attractive to the purchaser of the voting ticket of the race, for example. Meanwhile, many factors regarding the race conditions and the condition of the competitor or racehorse participating in the race may affect the race result. Therefore, the person in charge of organizing the program of the race organizes the program in consideration of various factors that may affect the race result, and thus requires a lot of knowledge and workload. For this reason, it is difficult for a person in charge who has little experience in the race program organization to organize an appropriate program, and it is desirable to acquire knowledge by developing experience in program organization.

When the person in charge acquires knowledge of program organization, it is desirable to appropriately evaluate the program organized by the person in charge. In particular, if the difficulty level of predicting the race result is known for the program organized by the person in charge, it is useful knowledge in organizing the program of a desired difficulty level. However, for example, with the device described in JP 2006-085441 A, it has been difficult to predict the difficulty level in predicting the race result.

Therefore, in order to solve the above problems, an object of the present disclosure is to provide a device and the like capable of predicting the difficulty level of predicting the race result from the information regarding the race organization.

By using the program information providing apparatus of the present disclosure, for example, the person in charge of race program organization can make an appropriate decision in the race organization. That is, the program information providing apparatus can support decision making in the race organization.

Some or all of the above example embodiments may be described as the following Supplementary Notes, but are not limited to the following.

### (Supplementary Note 1)

A program information providing apparatus comprising:
at least one memory storing instructions; and
at least one processor configured to execute the instructions to:
acquire information regarding race organization in a target race of a public competition; and
predict a difficulty level of a result prediction of the target race using a model in which a relationship between information regarding the race organization and a difficulty level of a race result prediction is machine-learned and the information regarding the race organization of the target race.

### (Supplementary Note 2)

The program information providing apparatus according to claim 1, in which
the at least one processor is further configured to execute the instructions to:
output the difficulty level of the target race to an output device.

### (Supplementary Note 3)

The program information providing apparatus according to Supplementary Note 2, in which
the at least one processor is further configured to execute the instructions to:
output information regarding the race organization in a past race.

### (Supplementary Note 4)

The program information providing apparatus according to Supplementary Note 3, in which
the at least one processor is further configured to execute the instructions to:
output information regarding the race organization in the past race selected based on a difficulty level of the target race.

### (Supplementary Note 5)

The program information providing apparatus according to Supplementary Note 3 or 4, in which
the at least one processor is further configured to execute the instructions to:
acquire a target difficulty level of the race result prediction in the target race; and
output information regarding the race organization in the past race selected based on the target difficulty level.

### (Supplementary Note 6)

The program information providing apparatus according to any one of Supplementary Notes 1 to 4, in which
the at least one processor is further configured to execute the instructions to:
create a program change proposal in which at least a part of information regarding the race organization in the target race is changed.

### (Supplementary Note 7)

The program information providing apparatus according to Supplementary Note 6, in which
the at least one processor is further configured to execute the instructions to:
acquire a target difficulty level of a race result prediction in the target race;
predict the difficulty level of at least one of the created program change proposals; and
output, to an output device, the program change proposal in which the predicted difficulty level matches the target difficulty level among the created program change proposals.

### (Supplementary Note 8)

The program information providing apparatus according to any one of Supplementary Notes 1 to 7, in which
the at least one processor is further configured to execute the instructions to:
acquire training data indicating a relationship between information regarding race organization in a race of the public competition and a difficulty level of result prediction of the race; and
generate a prediction model that predicts the difficulty level based on the information regarding the race organization by learning a relationship between the information regarding the race organization and the difficulty level of the race result prediction using the training data.

### (Supplementary Note 9)

A model generation device including:
an acquisition unit that acquires training data indicating a relationship between information regarding race organization in a race of the public competition and a difficulty level of result prediction of the race; and
a model generation unit that generates a prediction model that predicts the difficulty level based on the information regarding the race organization by learning a relationship between the information regarding the race organization and the difficulty level of the race result prediction using the training data.

### (Supplementary Note 10)

A program information providing method including:
acquiring information regarding race organization in a target race of a public competition; and
predicting a difficulty level of a result prediction of the target race using a model in which a relationship between information regarding the race organization and a difficulty level of a race result prediction is machine-learned and the information regarding the race organization of the target race.

### (Supplementary Note 11)

A model generation method including:
acquiring training data indicating a relationship between information regarding race organization in a race of the public competition and a difficulty level of result prediction of the race, and
generating a prediction model that predicts the difficulty level based on the information regarding the race organization by learning a relationship between the information regarding the race organization and the difficulty level of the race result prediction using the training data.

### (Supplementary Note 12)

A non-transitory recording medium recording a program that causes a computer to execute:
acquiring information regarding race organization in a target race of a public competition; and
predicting a difficulty level of a result prediction of the target race using a model in which a relationship between the information regarding the race organization and a difficulty level of a race result prediction is machine-learned and the information regarding the race organization of the target race.

### (Supplementary Note 13)

A non-transitory recording medium recording a program that causes a computer to execute:
acquiring training data indicating a relationship between information regarding race organization in a race of the public competition and a difficulty level of a result prediction of the race; and
generating a prediction model that predicts a difficulty level based on the information regarding the race organization by learning a relationship between the information regarding the race organization and the difficulty level of the race result prediction using the training data.

Some or all of the configurations described in Supplementary Notes 2 to 8 dependent on the above-described Supplementary Note 1 can also depend on Supplementary Notes 10 and 12 by the same dependency relationship as Supplementary Notes 2 to 8. Furthermore, not only the Supplementary Notes 1, 10, and 12 but also various recording means or systems for recording various pieces of hardware, software, and wear can be similarly dependent on some or all of the configurations described as the Supplementary Notes without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A program information providing apparatus comprising:
at least one memory storing instructions; and
at least one processor configured to execute the instructions to:
acquire information regarding race organization in a target race of a public competition; and
a prediction unit that predicts a difficulty level of a result prediction of the target race using a model in which a relationship between information regarding the race organization and a difficulty level of a race result prediction is machine-learned and the information regarding the race organization of the target race.

2. The program information providing apparatus according to claim 1, wherein
the at least one processor is further configured to execute the instructions to:
output the difficulty level of the target race to an output device.

3. The program information providing apparatus according to claim 2, wherein
the at least one processor is further configured to execute the instructions to:
output information regarding the race organization in a past race.

4. The program information providing apparatus according to claim 3, wherein
the at least one processor is further configured to execute the instructions to:
output information regarding the race organization in the past race selected based on a difficulty level of the target race.

5. The program information providing apparatus according to claim 3, wherein
the at least one processor is further configured to execute the instructions to:
acquire a target difficulty level of the race result prediction in the target race; and
output information regarding the race organization in the past race selected based on the target difficulty level.

6. The program information providing apparatus according to claim 1, wherein
the at least one processor is further configured to execute the instructions to:
create a program change proposal in which at least a part of information regarding the race organization in the target race is changed.

7. The program information providing apparatus according to claim 6, wherein
the at least one processor is further configured to execute the instructions to:
acquire a target difficulty level of a race result prediction in the target race;
predict the difficulty level of at least one of the created program change proposals; and
output, to an output device, the program change proposal in which the predicted difficulty level matches the target difficulty level among the created program change proposals.

8. The program information providing apparatus according to claim 1, wherein
the at least one processor is further configured to execute the instructions to:
acquire training data indicating a relationship between information regarding race organization in a race of the public competition and a difficulty level of result prediction of the race; and
generate a prediction model that predicts the difficulty level based on the information regarding the race organization by learning a relationship between the information regarding the race organization and the difficulty level of the race result prediction using the training data.

9. A program information providing method comprising:
acquiring information regarding race organization in a target race of a public competition; and
predicting a difficulty level of a result prediction of the target race using a model in which a relationship between information regarding the race organization and a difficulty level of a race result prediction is machine-learned and the information regarding the race organization of the target race.

10. The program information providing method according to claim 9, further comprising:
outputting the difficulty level of the target race to an output device.

11. The program information providing method according to claim 10, further comprising:
outputting information regarding the race organization in a past race.

12. The program information providing method according to claim 11, further comprising:
outputting information regarding the race organization in the past race selected based on a difficulty level of the target race.

13. The program information providing method according to claim 11, further comprising:
acquiring a target difficulty level of the race result prediction in the target race; and
outputting information regarding the race organization in the past race selected based on the target difficulty level.

14. The program information providing method according to claim 9, further comprising:
creating a program change proposal in which at least a part of information regarding the race organization in the target race is changed.

15. The program information providing method according to claim 14, further comprising:
acquiring a target difficulty level of race result prediction in the target race;
predicting the difficulty level of at least one of the created program change proposals by the prediction unit; and
outputting, to an output device, the program change proposal in which the predicted difficulty level matches the target difficulty level among the created program change proposals.

16. The program information providing method according to claim 9, further comprising:
acquiring training data indicating a relationship between information regarding race organization in a race of the public competition and a difficulty level of a result prediction of the race; and
generating a prediction model that predicts a difficulty level based on the information regarding the race organization by learning a relationship between the information regarding the race organization and the difficulty level of the race result prediction using the training data.

17. A non-transitory recording medium recording a program that causes a computer to execute:
acquiring information regarding race organization in a target race of a public competition; and
predicting a difficulty level of a result prediction of the target race using a model in which a relationship between the information regarding the race organization and a difficulty level of a race result prediction is machine-learned and the information regarding the race organization of the target race.

18. The non-transitory recording medium that records the program according to claim 17, wherein
the program further causes the computer to execute:
outputting the difficulty level of the target race to an output device.

19. The non-transitory recording medium that records the program according to claim 18, wherein
the program further causes the computer to execute:
outputting information regarding the race organization in a past race.

20. The non-transitory recording medium that records the program according to claim 17, wherein
the program further causes the computer to execute:
acquiring training data indicating a relationship between information regarding race organization in a race of the public competition and a difficulty level of a result prediction of the race; and
generating a prediction model that predicts a difficulty level based on the information regarding the race organization by learning a relationship between the information regarding the race organization and the difficulty level of the race result prediction using the training data.
